(19) United States
(12) Patent Application Publication
(10) Pub. No.: US 2010/0224086 A1
(43) Pub. Date: Sep. 9, 2010

(54) DISPOSABLE SLEEVE

(76) Inventor: MARCUS SCHEINBERGER, Hofheim-Langenhain (DE)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/700,309

(22) Filed: Feb. 4, 2010

(30) Foreign Application Priority Data
Feb. 6, 2009 (EP) 09 001 714.6

(51) Int. Cl. B30B 1/18

(52) U.S. Cl. 100/289

(57) ABSTRACT

A disposable sleeve for clamping of plate-shaped elements with an abutting face for the formation of a support area, a spacer section adjoining the abutting face and positioned in axial direction of the disposable sleeve, a segment formed on the opposite side of the abutting face for the introduction of axial forces, whereby a deformation segment, located between the spacer section and segment for the introduction of axial forces, is provided and formed as a groove in the outer surface of the sleeve, and which is designed in such a way that it deforms under a defined axial load in such a way that it results in a radially outward bulge. In order to allow for high clamping force, as well as uniform material stress of the plate-shaped elements, the groove is curtailed on the side opposite the abutting face through a radially positioned first recess.

### CROSS-REFERENCE TO RELATED APPLICATION

This application is a Section 111(a) application that claims the benefit of and priority to European Patent Application No. 09 001 714.6, filed on Feb. 6, 2009, the contents of which are incorporated by reference herein in its entirety.

### FIELD OF THE INVENTION

The present invention relates to a fastening assembly and, more particularly, to a disposable sleeve for clamping plate-shaped elements, and the application of a disposable sleeve for the clamping of a plate-shaped element with a hole.

### BACKGROUND OF THE INVENTION

For the manufacture of components having a sandwich design with several layers of light metal, fiber-reinforced plastics or similar materials, individual layers are, as a rule, glued together with the help of a hardening liquid sealant. In such circumstances, it is necessary to firmly set the individual layers of the sandwich assembly during the hardening process and to press them together by means of a defined preload. As a result, superfluous sealant is partly displaced from the layer structure. Consequently, disposable sleeves of the aforementioned type can be used. After the hardening of the sealant, and in order to hold the sandwich assembly together, the sleeves can be removed and blind rivets inserted in the holes.

Such disposable sleeves are inserted in the holes of the sandwich assembly and, in a first step, deformed, which results in a bead-like radially outward deformation. During a second step, the preloading of the sleeve relative to a counterpart (e.g., preload element) positioned on the other side of the sandwich assembly takes place, whereby the sleeve is in contact with the plate-shaped element of the sandwich assembly on the side of the deformation facing the preload element, while the rest of the sleeve is positioned in the hole of the sandwich assembly.

One example is a disposable sleeve that can be compressed by means of a feed shaft of a preload element, whereby the sleeve deforms into a deformation segment and turns radially outward. For this purpose, the sleeve displays a bulbous recess, which tapers the wall thickness in certain areas of the threaded sleeve. This weakened area serves as a defined initiation of the deformation of the sleeve. The bulge forms a contact surface, which adjoins the plate-shaped element of the sandwich assembly. At this point, the sleeve can be pulled toward the preload element by means of said preload element, whereby the sleeve and the preload element cause the compression of the individual layers of the sandwich assembly each time through respective contact surfaces.

In view of the foregoing, it is necessary for the aversion to take place in a predefined area while other areas of the sleeve, which, for example, brace themselves against the preload element, remain unaffected. In order to apply great clamping forces to the sandwich assembly, the disposable sleeve must be able to absorb great forces at the bulge without the bulge folding over and the sleeve sliding into the hole of the sandwich assembly.

### SUMMARY OF THE INVENTION

In an embodiment, a disposable sleeve includes a first end and a second end opposite the first end; an abutting face formed at the first end of the sleeve for the formation of a support area; a spacer section adjoining the abutting face and extending in an axial direction of the sleeve; a segment formed at the second end of the sleeve for the introduction of axial forces; and a deformation segment located between the spacer section and segment for the introduction of axial forces and formed as a groove within an outer surface of the sleeve, and which deforms under a defined axial load, resulting in a radially outward bulge. In an embodiment, the outward bulge can absorb great forces while the deformation occurs simultaneously in a predefined area of the sleeve. At the same time, the deformation of the disposable sleeve occurs homogenously, i.e., the bulge develops around the circumference substantially evenly in order to distribute the stress to the sandwich assembly in the area of the hole as substantially evenly and to avoid material damage. In an embodiment, the sleeve is a single piece sleeve.

In an embodiment, the groove is curtailed on a side opposite the abutting face through a radially positioned first recess. In an embodiment, the first recess is not strictly vertical to the longitudinal axis of the sleeve, but is formed substantially radially. In an embodiment, the area of the sleeve, which is weakened by the groove, deforms definedly through the axial forces acting upon the sleeve by forming a ring-shaped bulge. In an embodiment, the radial recess forms a notch, which facilitates the initiation of the bead-like bulge. Concurrently, in an embodiment, the bulge may form in such a way that it abuts the first recess. Therefore, the first recess can support the bulge, whereby greater forces can be absorbed when, during pre-loading, the deformed sleeve is pulled against the plate-shaped element of the sandwich assembly. Furthermore, in the deformation area, a bulge around the disposable sleeve is formed, which is particularly even. Therefore, the stress applied by the sleeve upon the plate-shaped element of the sandwich assembly is distributed more evenly in the area of the hole around the disposable sleeve.

In an embodiment, the groove is curtailed on the side facing the abutting face by a skewed and/or tiered second recess. In an embodiment, the recess may be positioned, for example, at a 45° angle to the longitudinal axis of the disposable sleeve.

In an embodiment, when the sleeve is pre-loaded after deforming, the contact surface abuts the outer layer of the sandwich assembly, whereby the second recess is positioned within the hole in the plate-shaped element of the sandwich assembly. In an embodiment, the bulge is shaped in such a way that it exhibits a strong curvature at its base at the disposable sleeve. The second recess causes the curvature not to come in contact with and possibly damage the inner wall or the edge of the hole of the sandwich assembly because the diameter of the sleeve in the area of deformation and, therefore, in the area where the curvature of the bulge is located, is smaller than the diameter of the hole of the plate-shaped element of the sandwich assembly. This prevents the occurrence of stress concentrations on the edge of the hole.

In an embodiment, the present invention provides for the segment, where the axial forces are introduced to the disposable sleeve, to be a female thread. As a result, the deformation forces may, for example, be introduced by means of a feed shaft, which can be screwed into the female thread of the sleeve. Thus, it is possible to pull the sleeve toward a respective counter element, e.g., a preload element, until the sleeve deforms under a defined force and forms the radially outward bulge.

In an embodiment, it is also possible to introduce the axial forces through compressive forces which, for example, are applied on the side opposite the abutting face of the sleeve. In another embodiment, it is also possible to pull the sleeve in another suitable manner toward the preload element until the bulge for the formation of the contact surface forms and an appropriate clamping force is achieved.

In another embodiment, if the outer diameter of the disposable sleeve in the area of the female thread segment is smaller than the diameter in the area of the spacer section, the axial forces in the sleeve in the area of the groove produce a momentum favorable for the deformation; and, therefore, the defined bulging is facilitated. In an embodiment, the wall thickness of the disposable sleeve in the area of the deformation segment is also reduced due to a cut-out on the inner surface. Due to this defined weakening, the bulging can be facilitated even further.

In another embodiment, it has proven advantageous to manufacture the sleeve, at least in certain areas, from a material which, at a defined stress, is plastically deformable through bulging in order to achieve sufficiently great clamping forces and a solid contact surface as well as deforming the disposable sleeve (e.g., with cylindrical exterior surface) homogenously and quickly to allow the bulge to form. In an embodiment, the sleeve is manufactured from aluminum. Particularly in connection with sandwich assemblies having nonparallel top and bottom elements, the use of such a sleeve is advantageous, since it allows the bulge to cling to the surface of the plate-shaped element which effects even material stress In the area of the hole of the plate-shaped element.

In another embodiment, the abutting face, which serves as a support area against a suitable pre-load element, exhibits means for centering, for example, a protrusion in an axial direction or a groove. This guarantees an effective support of the applied axial forces and supports the even formation of the bulge.

In an embodiment, the intrusion of contaminants into the female thread segment of the sleeve during the insertion of the sleeve into the hole of the plate-shaped elements of the sandwich assembly can be avoided with the addition of a cap on the second end of the sleeve opposite the abutting face of the sleeve. In another embodiment, the outer diameter of the cap is greater than the outer diameter of the spacer section. As a result, residues in the hole, such as adhesive residue or residue of the plate material, are removed and will not caulk the pre-load element. In an embodiment, it is particularly preferred if the sleeve is equipped with a wiper lip, which defines the outer diameter of the cap.

In an embodiment, the invention relates to the application of the aforementioned disposable sleeve for clamping of a plate-shaped element, whereby the disposable sleeve, after formation of the bulge, abuts the bulge against the element to be clamped. In this state, a radial clearance, which is formed by the second recess and/or the groove base of the deformation segment, remains between the inner wall of the hole and the second recess. The application of such a sleeve entails significant advantages, particularly in connection with tilted surfaces, since the sleeve can transfer great clamping forces while simultaneously allowing for optimal force distribution in the area of the hole of the plate-shaped element.

Refinements, advantages, and application possibilities of the invention result from the following description of exemplary embodiments and the drawing. All described and/or graphically illustrated features constitute the subject matter of the invention, as such or in any given combination, irrespective of their summary in the claims or back references thereof.

### BRIEF DESCRIPTION OF THE FIGURES

Reference is made to the following detailed description of the exemplary embodiment considered in conjunction with the accompanying drawings, in which:

FIG. 1 is side cross-sectional view of a longitudinal section of a disposable sleeve in accordance with an embodiment of the present invention, the sleeve being shown in a preinstalled position;

FIG. 2 is a side cross-sectional view of the disposable sleeve shown in FIG. 1, the sleeve being shown in an installed position and after deformation thereof; and

FIG. 3 is a detailed view of a bulge formed by the disposable sleeve shown in FIG. 2.

### DETAILED DESCRIPTION OF THE EMBODIMENTS

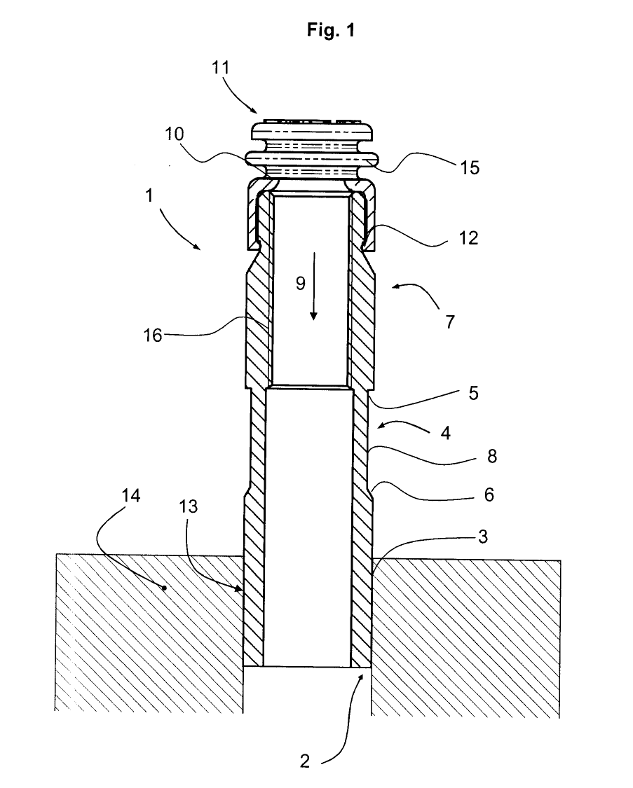

Referring to FIG. 1, an embodiment of a single-piece, disposable sleeve 1 includes an abutting face 2 for the formation of a support area, and a spacer section 3 adjoining the abutting face 2 and extending in an axial direction of the disposable sleeve 1. Adjacent to the spacer section 3, a groove 4 is positioned within an exterior surface of the disposable sleeve 1 and which is curtailed on a side opposite the abutting face 2 through a radially positioned first recess 5. Axially, on the other side of the groove 4, the groove 4 is curtailed by a skewed (e.g., tapered) second recess 6. Adjacent to the first recess 5, the disposable sleeve 1 includes a segment 7 for facilitating the introduction of axial forces. In an embodiment, as shown in FIG. 1, the interior surface of the disposable sleeve 1 is essentially smooth and cylindrical.

The groove 4 forms a deformation segment 8 between the first recess 5 and the second recess 6. In this segment 8, the wall thickness of the disposable sleeve 1 is comparatively small. In addition, arrow 9 depicted in FIG. 1 indicates the direction of the axial forces to be introduced on a top side 10 opposite of the abutting face 4 of the disposable sleeve 1.

In an embodiment, the disposable sleeve 1 includes a cap 11 which is fitted on the top side 10 of the disposable sleeve 1 and attached to the disposable sleeve 1 by means of a snap fastener 12. FIG. 1 shows the disposable sleeve 1 after it is inserted through a hole 13 in a plate-shaped element 14 of a sandwich assembly (not completely shown in the Figures). In an embodiment, the cap 11 includes at least one wiper lip 15 that extends outwardly therefrom and circumferentially. The outer diameter of the wiper lip 15 is greater than the widest outer diameter of the actual disposable sleeve 1. When the disposable sleeve 1 is pushed through the hole 13 of the plate-shaped element 14 headfirst with the cap 11 mounted to the top side 10, adhesive residue or even material residue of the plate-shaped element can be removed from the hole 13.

In an embodiment, the segment 7 for the introduction of axial forces includes a female thread 16 for the introduction of axial forces. This allows for a feed shaft (not shown in the Figures), which is inserted into the disposable sleeve 1 through the abutting face 2 and equipped with an appropriate male thread, to grip the female thread 16 and apply the axial forces in the direction of arrow 9. In order to achieve a deformation of the disposable sleeve 1, the abutting face 2 is designed as a support area, through which the applied axial forces 9, in a component not depicted in the Figures, can be supported.

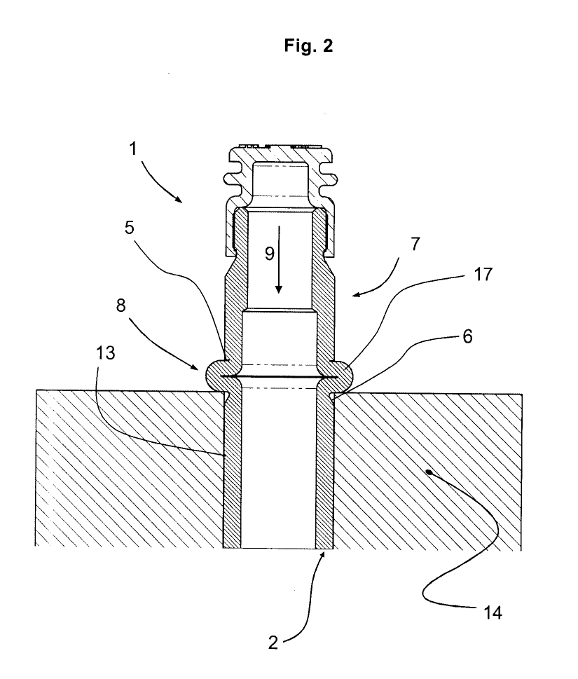

Referring to FIG. 2, an embodiment of the disposable sleeve 1 is shown as deformed, whereby the female thread 16 is not depicted. The disposable sleeve 1, which, in an embodiment, is made of aluminum, deforms within the deformation segment 8 at a determined axial force 9 in such a way that a radially outward, bead-like bulge 17 is formed between the first recess 5 and the second recess 6. In another embodiment, the disposable sleeve 1 is made from other suitable materials known in the art.

The disposable sleeve 1 is preloaded against the plate-shaped element 14 by pulling the disposable sleeve 1 into the hole 13 until the disposable sleeve 1 with the bulge 17 abuts the plate-shaped element 14, as shown in FIG. 2. The bulge 17 abuts one side of the plate-shaped element 14 and is supported by the first recess 5. Thus, the bulge 17 can simultaneously exert great forces onto the top of the plate-shaped element 14. This way, the sandwich assembly can be pre-loaded with great clamping forces.

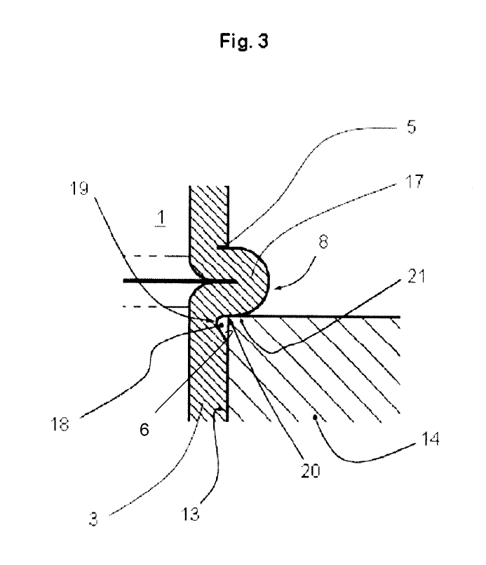

Referring to FIG. 3, the bulge 17 at the top of the plate-shaped element 14 in the deformation segment 8 is formed in such a way that the bulging essentially takes place in front of and/or adjacent to the second recess 6. While the spacer section 3 abuts the inner wall of hole 13, a radial clearance 18 is formed in the area of the second recess 6 between the disposable sleeve 1 and the inner wall of hole 13. The bulge 17 exhibits a curvature 19 in the direction of the second recess 6, but which lies in the area of the radial clearance 18 and, therefore, makes no contact with an edge 20 of the hole 13. Instead, the bulge 17 rests with a virtually flat area 21 on the surface of the plate-shaped element 14. Thus, an even and virtually ring-shaped material stress of the plate-shaped element 14 is applied around the disposable sleeve 1, whereby great clamping forces within the sandwich assembly are facilitated without material damage thereto.

It will be understood that the embodiments of the disposable sleeve 1 described herein are merely exemplary and that a person skilled in the art may make many variations and modifications without departing from the full spirit and the scope of the embodiments described herein. Accordingly, all such variations and modifications are intended to be included within the scope of the invention as defined in the appended claims.

What is claimed is:

1. A disposable sleeve adapted to clamp plate-shaped elements to one another comprising:
a first end and a second end opposite the first end;
an abutting face located at the first end and forming a support area for a preload element;
a spacer section adjoining the abutting face and extending in an axial direction of the disposable sleeve;
a first segment formed at the second end for facilitating the introduction of axial forces on the sleeve; and
a deformation segment located between the spacer section and the first segment, the deformation segment including a groove formed within an outer surface of the sleeve, whereby the deformation segment deforms under a defined axial load applied to the sleeve and forms a radially outward bulge, whereby the groove is curtailed on a side opposite the abutting face through a radially positioned first recess.

2. The disposable sleeve as claimed in claim 1, wherein the groove is curtailed on a side facing the abutting face by a skewed and tiered second recess.

3. The disposable sleeve as claimed in claim 1, wherein the first segment includes a female thread.

4. The disposable sleeve as claimed in claim 1, wherein an outer diameter of the first segment is smaller than an outer diameter of the spacer section.

5. The disposable sleeve as claimed in claim 1, wherein the deformation segment includes an inner surface and a cutout located on the inner surface for reducing a wall thickness of the deformation segment.

6. The disposable sleeve as claimed in claim 1, wherein the sleeve is made from a material which is plastically deformable through bulging.

7. The disposable sleeve as claimed in claim 6, wherein the sleeve is made from aluminum.

8. The disposable sleeve as claimed in claim 1, wherein the abutting face includes means for centering the sleeve.

9. The disposable sleeve as claimed in claim 1, wherein the means for centering the sleeve includes a protrusion.

10. The disposable sleeve as claimed in claim 9, wherein the means for centering the sleeve includes a groove.

11. The disposable sleeve as claimed in claim 4, further comprising a cap mounted on the second end.

12. The disposable sleeve as claimed in claim 11, wherein the cap includes a wiper lip having an outer diameter that is greater than the outer diameter of the spacer section.

13. A disposable sleeve adapted to be installed within a hole of and clamp a plate-shaped element, comprising:
a first end and a second end opposite the first end;
an abutting face located at the first end and forming a support area for a preload element;
a spacer section adjoining the abutting face and extending in an axial direction of the disposable sleeve;
a first segment formed at the second end for facilitating the introduction of axial forces on the sleeve; and
a deformation segment located between the spacer section and the first segment, the deformation segment including a groove formed within an outer surface of the sleeve, whereby the deformation segment deforms under a defined axial load applied to the sleeve and forms a radially outward bulge, whereby the groove is curtailed on a side opposite the abutting face through a radially positioned first recess and on a side facing the abutting face by a skewed and tiered second recess, wherein when the pin is installed within the hole of the plate-shaped element, the bulge abuts the plate-shaped element and forms a radial clearance between an inner wall of the hole and the second recess.

14. The disposable sleeve as claimed in claim 13, wherein the first segment includes a female thread.

15. The disposable sleeve as claimed in claim 13, wherein an outer diameter of the first segment is smaller than an outer diameter of the spacer section.

16. The disposable sleeve as claimed in claim 13, wherein the deformation segment includes an inner surface and a cutout located on the inner surface for reducing a wall thickness of the deformation segment.

17. The disposable sleeve as claimed in claim 13, wherein the sleeve is made from a material which, at a defined stress, is plastically deformable through bulging.

18. The disposable sleeve as claimed in claim 17, wherein the sleeve is made from aluminum.

19. The disposable sleeve as claimed in claim 13, wherein the abutting face includes means for centering the sleeve.

20. The disposable sleeve as claimed in claim 19, wherein the means for centering includes a protrusion.

21. The disposable sleeve as claimed in claim 19, wherein the means for centering includes a groove.

22. The disposable sleeve as claimed in claim 1, further comprising a cap mounted on the second end.

23. The disposable sleeve as claimed in claim 22, wherein the cap includes a wiper lip having an outer diameter that is greater than the outer diameter of the spacer section.
